(19) United States
(12) Patent Application Publication
(10) Pub. No.: US 2011/0211818 A1
(43) Pub. Date: Sep. 1, 2011

(54) Fracturing Tank Fluid Heating

(75) Inventor: Bradley R. Grady, Cleburne, TX (US)

(73) Assignee: Grady Rentals, LLC, Cleburne, TX (US)

(21) Appl. No.: 12/714,805

(22) Filed: Mar. 1, 2010

(51) Int. Cl. H05B 3/78; B60P 3/22; H05B 3/82; B62D 33/00

(52) U.S. Cl. 392/444; 137/899; 392/500; 392/501; 220/562

(57) ABSTRACT

Fracturing fluid in a fluid tank is heated at a wellsite to protect against freezing of the fluid because of cold weather conditions. Convection currents induced in the fluid during heating cause fluid circulation in the tank to stir the fluid without additional equipment for that purpose.

### BACKGROUND OF THE INVENTION

1. Field of the Invention

The present invention relates to fracturing fluid tanks for wells and adapted for cold weather operations.

2. Description of the Related Art

Fracturing fluids are used in wells to stimulate enhanced production of oil and gas from subterranean formations. The fluids used have been of considerable volumes of water and contain additive compounds or compositions such as acids, particles or other additives which have been selected based on what can be determined about the nature and conditions of the formation to be fractured. The fluids are stored in large tanks near the wellsite, and the tanks typically contain several thousands or more gallons of fluid. The fracturing fluids are pumped from the fracturing fluid tank and injected under pressure into the well at the depth of the formation selected and isolated for receipt of fluid.

The fluid tanks at the wellsite are usually positioned on or very near the ground level, and may be modular or include transport wheels and transport connections for a transport truck or tractor for ease of movement to and from different well sites over the service life of the tank.

Certain formations containing hydrocarbons are located in areas where winter temperature conditions are well below freezing temperature. These climate conditions give rise to the risk of freezing of the fracturing fluids in the fracturing fluid storage tanks, which can impair if not completely interrupt well fracturing operations. Freezing of fracturing fluids in the tanks could result in interruption of fracturing operations with the expense in lost cost of rental equipment, and also the time and wages for the service and rig crew, as well as the risk of damage to costly pumps and other equipment at the wellsite.

### SUMMARY OF THE INVENTION

Briefly, the present invention provides a new and improved well fracturing fluid tank for operation in low temperature conditions. The fracturing fluid container tank according to the present invention receives a supply of fracturing fluid for application to a subterranean formation accessible by the well to fracture the formation. A fracturing fluid heater is located in the fracturing fluid container tank for maintaining the fracturing fluid above freezing temperature in low temperature weather conditions; and a mounting attachment is provided for mounting the fracturing fluid heater with the fracturing fluid container tank.

The present invention also provides a new and improved fracturing fluid heater for a fracturing fluid container tank for maintaining the fracturing fluid in the container tank above freezing temperature in low temperature weather conditions. A group of heating elements is insertable into a position extending into the fracturing fluid container tank, and a mounting attachment is provided for mounting the heating elements with the fracturing fluid container tank. The fluid heater according to the present invention may be located at several locations on the fracturing fluid tank based on usage or operational requirements.

### BRIEF DESCRIPTION OF THE DRAWINGS

FIG. 1 is a side elevation of a fracturing fluid tank according to the present invention.

FIG. 2 is plan view of the structure of FIG. 1.

FIG. 3 is a side elevation view of a fracturing fluid heater according to the present invention.

FIG. 4 is plan view of the structure of FIG. 3.

FIGS. 5 and 6 are isometric views of portions of the structure of FIG. 3.

FIG. 7 is a view taken along the lines 7-7 of FIG. 1.

FIG. 8 is a side elevation of an alternative form of fracturing fluid heater according to the present invention.

FIG. 9 is a graph illustrating tank fluid temperature increase as a function of temperature difference between the tank fluid and ambient temperature.

### DETAILED DESCRIPTION OF THE PREFERRED EMBODIMENTS

In the drawings, the letter T designates generally a heated container tank for fracturing fluids according to the present invention. The tank T may be of any suitable size, often from forty to fifty feet in length and from eight to ten feet in height and width. The size and number of tanks at a well as well as the components and composition in the fracturing contained in such tanks is based on the particular formation fracturing operation being encountered.

The tank T in the embodiment shown in the drawings is provided with a suitable connector hitch or fifth wheel connection 20 at a front end 22 and a set of rear wheels 24 at a rear end portion 26. The tank T may thus be attached to a transport truck or tractor and moved to and from well sites as usage needs require. It should be understood that the tank T according to the present invention may take other forms than the road transportable one shown, such as skid or pallet mounted, if desired.

A roof or top cover 30 of tank T is provided with a manhole hatch or opening 32 typically at a central portion of the roof. As will be set forth, the hatch 32 is used as an access port for insertion and attachment of a heating element for maintaining the temperature of the fracturing fluid above freezing temperature during cold weather at the well site. The tank T is also provided with the usual conventional features such as valves, manifolds, gauges, stairs or ladders, feed lines and connector ports. These conventional features are not illustrated in the drawings in order that the heating structure and components may more readily be seen.

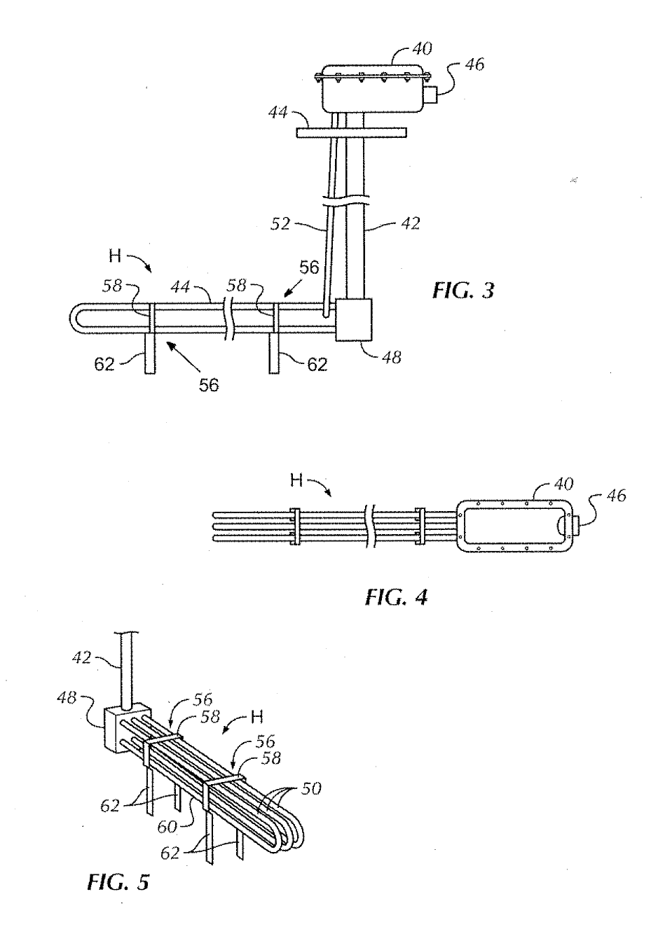

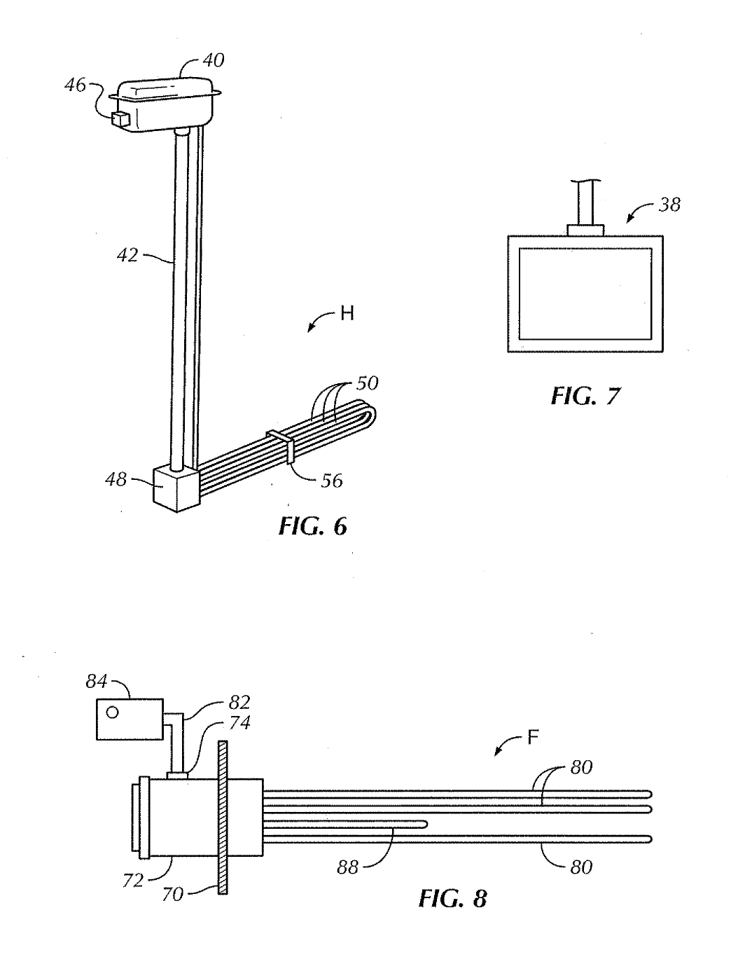

According to the present invention, the tank T is heated by a fracturing fluid heater located in the tank which maintains the fracturing fluid above freezing temperature in low temperature weather conditions. The fluid heater according to the present invention may be located at several locations on the fracturing fluid tank T based on usage or operational requirements. The fracturing fluid heater according to the present invention may take the form of an insertable or drop in heating unit H (FIGS. 3-6) or a flange mounted heating unit F (FIGS. 7-8).

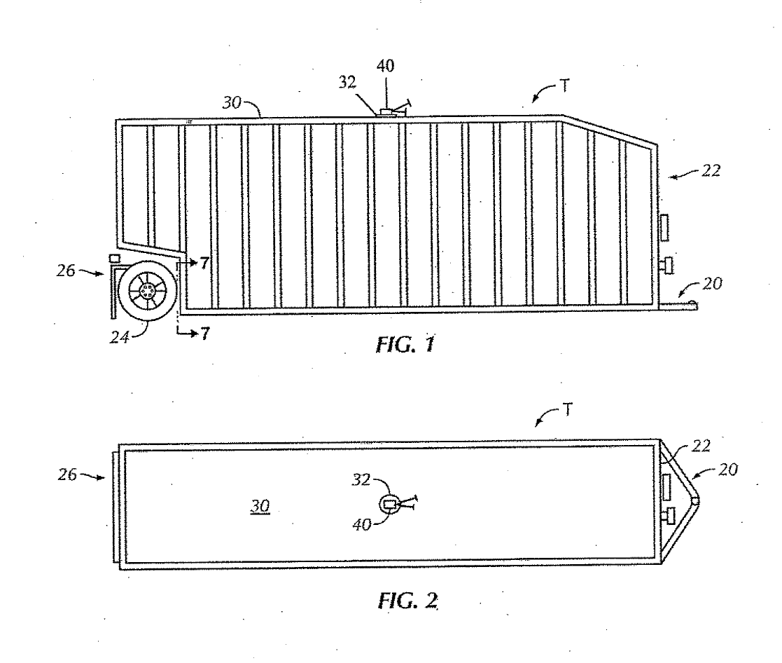

The insertable or drop in heating unit H is positioned into the interior of the tank T by access through the hatch 32 on the roof 30, while the flange mounted heating unit is mounted at a bottom flange 38 at the rear portion 26 forward of the wheels 24 (FIG. 1). The fluid heaters according to the present invention may be located at several locations on the fracturing fluid tank T shown in the drawings if desired, based on usage or operational requirements. For skid or pallet mounted tanks, the flange mounted unit F may be attached at a suitable flange or other portal in the side wall, depending on the construction of such tanks.

The insertable or drop in heating unit H includes a moisture resistant enclosure or connector box 40 mounted atop a tube riser 42 above a cover plate 44. The cover plate 44 is of a size adapted to fit over and cover the hatch 32 when the heating unit H is positioned in the tank T, and of a thickness and strength to support the weight of the unit H in the tank T. The cover plate 44 also reduces heat loss through the hatch 32. The cover plate 44 may be bolted or otherwise attached in position covering the hatch 32 if desired. The cover plate is not shown in FIGS. 4, 5 and 6 in order that other structure of the heating unit H may be more clearly seen.

The connector box 40 is provided with an electrical connector port 46 for receiving and electrically connecting the heating unit H to electrical power conductors providing power to the heating unit H from a suitable source of power at the well site. Typically, the connector box 40 is provided with indicator lights to inform operators and crew that the heating unit is receiving electrical power. Electrical conductors of suitable power rating are connected to the connector port 46 and extend with in the connector box 40 and downwardly through the interior of tube riser 42 to a heating element junction box 48 mounted at a lower end of the tube riser 42.

A suitable number of heating elements 50 are mounted extending laterally outwardly from each junction box 48 and are electrically connected through the conductors in junction box 48 to receive power and generate heat. In a number of cases, the junction box 48 may have two or more bundles like that shown at 50. The heating elements 50 convert the electrical which is provided there into heat, and the amount of heat which the heating elements provide is based on the amount of power furnished them. In addition, if desired, a tube 52 may be attached to the connector box 40 so that temperature or heat sensing or measuring instrumentation may be positioned within the interior of the tank T in the vicinity of the heating elements 50 as shown.

The temperature measuring instrumentation in tube 52 is preferably a temperature measuring instrument, electronic or otherwise, and is included as part of a thermostatic control circuit. The thermostatic control circuit may be located in the connector box 40 where so that thermostatic control of temperature conditions of the fracturing fluid in the tank T is furnished at the tank location. It should be understood that the thermostatic control circuit may be located at other positions at the well site if desired. The thermostatic control circuit may be of the conventional type to regulate the flow of electrical power to the heating elements 50 based on measured temperature conditions of the fracturing fluid in the vicinity of the heating unit H. Based on the measured fracturing fluid temperature conditions, the flow of power to the heating elements 50 is adjusted to maintain fluid temperatures at a specified level. It should be understood that in some situations, thermostatic control is optional and may not be needed or included.

The heating elements 50 are in the form of elongate U-shaped insulated electrical heating elements, usually in the form of rods, bars or wires, extending laterally into the tank T from the junction box 48. The heating elements 50 operate at temperatures according to the amount of electrical power provided them in order to heat the fracturing fluids in the tank T. The specific length and size of the heating elements used in the tank T are selected based on fluid volume, tank dimensions, expected temperature conditions at the well site, and other factors. For a typical, conventional fracturing fluid tank T, the heating elements 50 extend inwardly from the junction box 48 from four to five feet. The junction box 48 is located by the riser tube some ten feet, for example, below the connector box based on the size of the tank T, for example.

The heating system according to the present invention is capable of maintaining fracturing fluid tank water above freezing in ambient air temperature as low as −20° F. Each tank T at a well site requires a heater H, and the heater must be energized continuously when ambient air temperature is below 36° F.

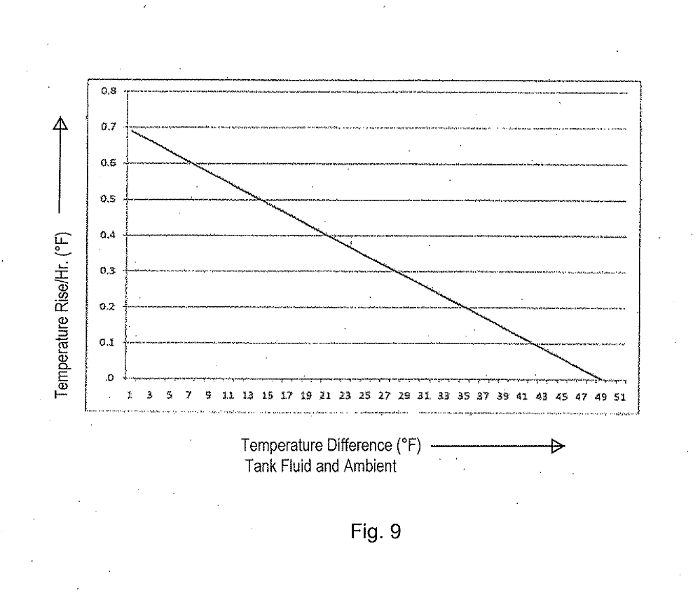

FIG. 9 illustrates the relation, according to an example described below, between the amount of the temperature rise tank fluid experiences per hour (y-axis) as a function of the fluid temperature difference between the tank fluid and ambient temperature (x-axis). As can be seen, when fluid temperature equals the ambient temperature, the tank fluid experiences a temperature rise of 0.7° F. per hour. When the tank fluid temperature is 49° F. hotter than the ambient temperature, the tank fluid temperature can be maintained at a steady level.

The data shown in FIG. 9 is based on the following parameters:
Fluid=Water
Gallons of fluid=21,000
Surface area of the tank=1,400 square feet
Factor of Safety=15%

HL=0.6×A₃×ΔT_{A}×FOS
Where,
HL=Heat Loss in Watts
A_{S}=Surface Area in square feet
ΔT_{A}=Fluid Temperature minus the Ambient Temperature in ° F.
FOS=the Factor of Safety

$$Δ {T}_{F} = \frac{kW \times 410}{Gallons}$$

Where,
ΔT_{F}=the rise in Fluid Temperature per Hour in ° F.
kW=Kilowatts Output from the Heater
Gallons=The gallons of fluid to be heated

The fracturing fluid tank heating analysis calculations for the data of FIG. 9 are:
Tank Dimensions: 45 feet Long×8.5 feet Wide×9.5 feet High
Total Surface Area: 1782 Square Feet
Heat Loss Surface Area: 1400 Square Feet
   NOTE: While the FRAC tank is sitting slightly above the ground, heat losses from the underside are deemed negligible.
Tank Potential Volume: 21,000 Gallons
   NOTE: 21,000 gal=175,140 lbs of water (1 gal=8.34 lbs)
Heat Loss at −20° F.: 0.6 W×Surface Area×ΔT (maintaining above 32° F.)
Heat Energy Stored in Water: E=cp×ΔT×Mass of Water (assuming the heater is energized at ambient air temperatures below 36°) (BTU/3412=KW)

Latent Heat of Fusion:
Water releases 80 Calories per gram of energy in phase change from water to ice or 140 BTU/LB. L=Q/m (1 cal=0.0039 BTU while 1 gram=0.0022 lb)

The heating elements 50 are supported at selected locations along their extent by a suitable number of standoff assemblies or sludge legs 56. The sludge legs 56 are support members in the form of an upright plate or panel 58 with opening ports or slots 60 to receive and allow the heating elements 50 to pass through and receive structural support in the tank T. The sludge legs 56 include a set of downwardly extending spacer legs 62 which rest at their lower ends on the floor of the interior of the tank T. The vertical extent of the spacer legs 62 is deteiiuined by the expected amount of sludge or sediment expected in the fracturing fluid and may be on the order of from four to six inches. The spacer legs 62 can be provided with extended lower portions or other form of pads or footing at their base for firm support of the heating elements 50 above the floor of the tank T. The heating elements 50 are elevated above the level of sludge or sediment in the tank T by the spacer legs 62 so that heat is provided directly to the fluids and not into the sludge or sediment typically present near the floor of fracturing fluid tanks.

Turning to the flange mounted heating unit F (FIGS. 7-8), a flange plate 70 of a size adapted to be fitted and held in place in sealing engagement with the bottom flange 38 of the tank T by suitable gaskets or seals. Connection of the flange plate 70 to the flange 38 is made by bolts or other connectors, as shown in FIGS. 1 and 7. The flange plate 70 is of a thickness and strength to support the weight of the unit F in the tank T.

The flange mounted heating unit F includes a moisture resistant enclosure or connector box 72 mounted with the flange plate 70. The connector box 72 is provided with an electrical connector port 74 for electrical connection of the heating unit F through external electrical power conductors to power available at the well site. Electrical conductors within the connector box 72 extend between the connector port 74 and heating elements 80. The heating elements 80 are of comparable characteristics to the heating elements 50. The specific length and size of the heating elements 80 are chosen based on fluid volume, tank dimensions, expected temperature conditions, and the like, as is the case with heating elements 50.

The connector box 72 is also connected by a conduit 82 so that electronics within a thermostatic control box 84 can regulate the flow of power and thus the amount furnished by the heating unit F to the fracturing fluids in the tank T. The connector box 72 is also preferably provided with indicator lights to indicate the operating condition of the heating unit F.

The heating elements 80 are mounted extending laterally outwardly from the flange plate 70 into the interior of the tank T and receive electrical power to generate heat for the fluid in the tank T. The location of the heating elements 80 in the tank T due to mounting on the flange plate 70 above the floor of the tank T normally precludes a need for the presence of for sludge legs in the heating unit F.

As in the case of the drop in unit H, the flange mounted heating unit F may, if desired, include a probe or tube 88 attached to extend inwardly into the interior of the tank T in the vicinity of the heating elements 80. Temperature or heat sensing or measuring instrumentation may be positioned in the probe 88. The temperature sensing instrumentation is connected as part of the thermostatic control circuit located in the theinostatic control box 84. In this manner, the amount of electrical power flowing to the heating elements 80 may be regulated where close thermostatic control of temperature conditions of the fracturing fluid is desired. The thermostatic control circuit is preferably of the conventional type discussed above. Thermostatic temperature control regulates the flow of electrical power to the heating elements 80 based on measured temperature conditions of the fracturing fluid to maintain fluid temperatures at a specified temperature level.

The heating elements 80 are in the form of elongate U-shaped electrical heating wires operating at temperatures according to the amount of electrical power provided in order to heat the fracturing fluids in the tank T. The specific length and size of the heating elements for the heating unit F are based on fluid volume, tank dimensions, expected temperature conditions at the well site, and other factors.

In the operation of the present invention, a heating unit to maintain the temperature of fracturing fluids above freezing is positioned in the tank T. The selection of either a drop in heating unit H or a flange mounted unit F is usually based on accessibility or availability of flanges on the tank T or on conditions and space allocation at the well site. Freeze protection of the associated external piping and interconnections between the tank T and other fracturing fluid handling or delivery equipment at the site is provided by heat tracer elements on the piping and interconnections.

Electrical power is furnished to the installed heating unit in the tank T based on the difference between ambient temperature at the site and fluid temperature in the tank T. The amount of power applied may be varied based on the amount of such temperature difference. It has been found preferable to maintain the application of electrical power continuously once ambient temperature reaches some point near freezing temperature (32° F.), usually in the mid-30's Fahrenheit. It has been found that fluids in fracturing tanks are maintained in the tanks at a usable state in situations where ambient temperatures of −20° F. are present. The convection currents introduced into the fluids by heating elements cause adequate movement of the fluids without the need for additional mechanical assistance from impeller blades or the like to maintain fluid circulation.

The invention has been sufficiently described so that a person with average knowledge in the matter may reproduce and obtain the results mentioned in the invention herein Nonetheless, any skilled person in the field of technique, subject of the invention herein, may carry out modifications not described in the request herein, to apply these modifications to a determined structure, or in the manufacturing process of the same, requires the claimed matter in the following claims; such structures shall be covered within the scope of the invention.

It should be noted and understood that there can be improvements and modifications made of the present invention described in detail above without departing from the spirit or scope of the invention as set forth in the accompanying claims.

What is claimed is:

1. A well fracturing fluid tank for operation in low temperature conditions, comprising:
a fracturing fluid container tank receiving a supply of fracturing fluid for application to a subterranean formation accessible by the well to fracture the formation;
a fracturing fluid heater located in the a fracturing fluid container tank for maintaining the fracturing fluid above freezing temperature in low temperature weather conditions; and
a mounting attachment for mounting the fracturing fluid heater with the fracturing fluid container tank.

2. The fracturing fluid tank of claim 1, wherein the fracturing fluid heater comprises a plurality of heating elements extending into the fracturing fluid container tank.

3. The fracturing fluid tank of claim 1, wherein the heating elements comprise electrical heating elements.

4. The fracturing fluid tank of claim 3, further including an electrical junction box mounted with the mounting attachment for connecting the electrical heating elements to a source of operating electrical power.

5. The fracturing fluid tank of claim 1, further including a heat sensor mounted with the mounting attachment for sensing temperature conditions in the fracturing fluid.

6. The fracturing fluid tank of claim 1, wherein the fracturing fluid container tank has an access hatch formed in an upper cover and the mounting attachment comprises a cover plate mounted over the access hatch.

7. The fracturing fluid tank of claim 1, wherein the mounting attachment further comprises:
a tube riser extending downwardly from the access hatch; and
a junction box mounted at a lower end of the tube riser.

8. The fracturing fluid tank of claim 7, wherein the fracturing fluid heater comprises a plurality of heating elements extending from the junction box into the fracturing fluid container tank.

9. The fracturing fluid tank of claim 8, further including at least one support spacer assembly mounted with the heating elements along their extent above a floor level in the tank.

10. The fracturing fluid tank of claim 1, wherein the fracturing fluid container tank has a bottom flange at a rear portion and the mounting attachment comprises a cover plate mounted in engagement with the bottom flange.

11. The fracturing fluid tank of claim 10, wherein the fracturing fluid heater comprises a plurality of heating elements extending inwardly into the fracturing fluid container tank from the cover plate.

12. A fracturing fluid heater for a fracturing fluid container tank for maintaining the fracturing fluid in the container tank above freezing temperature in low temperature weather conditions, comprising:
a plurality of heating elements insertable into a position extending into the fracturing fluid container tank; and
a mounting attachment for mounting the heating elements with the fracturing fluid container tank.

13. The fracturing fluid heater of claim 12, wherein the heating elements comprise electrical heating elements.

14. The fracturing fluid heater of claim 13, further including an electrical junction box mounted with the mounting attachment for connecting the electrical heating elements to a source of operating electrical power.

15. The fracturing fluid heater of claim 12, further including a heat sensor mounted with the mounting attachment for sensing temperature conditions in the fracturing fluid.

16. The fracturing fluid heater of claim 12, wherein the mounting attachment comprises a cover plate for mounting over an access hatch formed in an upper cover of a fracturing fluid container tank.

17. The fracturing fluid heater of claim 16, wherein the mounting attachment further comprises:
a tube riser extending downwardly from the cover plate; and
a junction box mounted at a lower end of the tube riser.

18. The fracturing fluid heater of claim 17, wherein the heating elements are mounted extending from the junction box.

19. The fracturing fluid heater of claim 12, wherein mounting attachment comprises a cover plate mounted in engagement with a bottom flange at a rear portion of a fracturing fluid container tank.

20. The fracturing fluid heater of claim 19, wherein the heating elements are mounted for inward extension form the cover plate into a fracturing fluid container tank.
